(19) United States
(12) Patent Application Publication
(10) Pub. No.: US 2009/0058828 A1
(43) Pub. Date: Mar. 5, 2009

(54) ELECTRONIC DEVICE AND METHOD OF OPERATING THE SAME

(75) Inventors: Shannu JIANG, Suwon-si (KR); Young-Wan Seo, Suwon-si (KR); Ho-kyung Kim, Seongnam-si (KR); Il-gu Chang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd, Suwon-si (KR)

(21) Appl. No.: 12/193,937

(22) Filed: Aug. 19, 2008

(30) Foreign Application Priority Data
Aug. 20, 2007 (KR) 10-2007-0083392

(51) Int. Cl. G06F 3/041

(52) U.S. Cl. 345/173

(57) ABSTRACT

An electronic device and a method of operating the same are provided. The electronic device includes a touch-sensing module sensing a change in a touch, a processing module determining a display screen layer associated with a touch location, and a screen display module displaying a part of the display screen layer.

### CROSS-REFERENCE TO RELATED APPLICATION

This application claims priority from Korean Patent Application No. 10-2007-0083392 filed on Aug. 20, 2007 in the Korean Intellectual Property Office, the disclosure of which is incorporated herein by reference in its entirety.

### BACKGROUND OF THE INVENTION

1. Field of the Invention

Methods and apparatuses consistent with the present invention relate to providing an intuitive GUI actuated by operating the same through a one-time manipulation.

2. Description of the Related Art

In recent years, to achieve compactness and lightness, handheld electronic devices, such as MP3 players, PMP (Portable Multimedia Players), cellular phones, PDAs (Personal Digital Assistants), or UMPCs (Ultra-Mobile PCs), have been manufactured with touch screens enabling users to control them by using the information display screen with their fingers, stylus pens, and other devices, without the use of input buttons. To meet needs for user convenience, touch screens have been applied to ticket-vending machines, public information kiosks, and others.

A touch screen is a display device that enables information display and input operations to be conducted on the same display screen. User-computer interaction is activated by a user touching graphics or text displayed on the display screen.

Data input operations consist of a tapping operation of touching a predetermined point on a surface of the touch screen one time to execute a corresponding object corresponding to the contact point of the touch screen, a dragging operation of selecting a corresponding object displayed on a touch screen by pressing the object for a predetermined period of time to move the same to another location, and a holding operation of invoking a corresponding object such as a sub-menu item by pressing down a predetermined location on a surface of the touch screen.

One problem with existing mobile devices having touch screens is that there is no preview functionality provided to a user. The user of a touch screen is therefore not able to preview a display screen until an operation for initiating a new task is activated, and if the display screen displayed by activating the operation is not desired one, the user returns to the previous stage to make a new selection until a desired display screen is displayed on the touch screen. That is, two or more operations are involved, which is quite cumbersome. In addition, since the existing GUI-based touch screen is substantially the same as that used for the conventional PC, an intuitive GUI designed to fully exploit benefits of a touch screen cannot be provided.

### SUMMARY OF THE INVENTION

In order to overcome the above-described problems, the present invention provides an electronic device and a method of operating the same, which can provide preview and execution operations through a simple manipulation. Also, the present invention is not required to overcome the above-described problems, and an exemplary embodiment of the present invention may not overcome any of the problems described above.

The present invention also provides an intuitive graphic user interface (GUI) to a user.

These and other objects of the present invention will be described in or be apparent from the following description of the exemplary embodiments.

According to an aspect of the present invention, there is provided an electronic device including a touch-sensing module sensing a touch, a processing module determining a display screen layer associated with a location of the touch, and a screen display module displaying a part of the display screen layer.

According to an aspect of the present invention, there is provided a method of operating an electronic device, the method including sensing a touch, displaying a part of a display screen layer associated with the location of the touch, determining whether there is a change in the touch, and displaying a changed display screen layer according to the change in the touch.

### BRIEF DESCRIPTION OF THE DRAWINGS

The above and other features and advantages of the present invention will become apparent by describing in detail exemplary embodiments thereof with reference to the attached drawings in which:

FIG. 1 is a block diagram of an electronic device according to an exemplary embodiment of the present invention;

FIG. 2 is a flowchart illustrating a method of operating an electronic device according to an exemplary embodiment of the present invention;

FIGS. 3 through 5 are views illustrating exemplary display screens displayed by touching the displaying screens in a method of operating an electronic device according to an exemplary embodiment of the present invention;

FIG. 6 is a view illustrating an exemplary display screen displayed when a location of a touch is moved in a method of operating an electronic device according to an exemplary embodiment of the present invention;

FIG. 7 is a view illustrating an exemplary display screen displayed when a location of a touch is moved and the touch is then released in a method of operating an electronic device according to an exemplary embodiment of the present invention; and

FIG. 8 is a view illustrating an exemplary display screen displayed when a touch is maintained for a predetermined time in a method of operating an electronic device according to an exemplary embodiment of the present invention.

### DETAILED DESCRIPTION OF THE INVENTION

Features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. In addition, in the drawings, the thickness of layers and regions are exaggerated for clarity.

An electronic device and a method of operating the same will be described hereinafter with reference to flowchart illustrations of methods according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to create means for implementing the functions specified in the flowchart block or blocks.

These computer program instructions may also be stored in a computer usable or computer-readable memory that can direct a computer or other programmable data processing apparatus to function in a particular manner, such that the instructions implement the function specified in the flowchart block or blocks.

The computer program instructions may also be loaded into a computer or other programmable data processing apparatus to cause a series of operations to be performed on the computer or other programmable apparatus to produce a computer implemented process for implementing the functions specified in the flowchart block or blocks.

In addition, each block may represent a module, a segment, or a portion of code, which may comprise one or more executable instructions for implementing the specified logical functions. It should also be noted that in other implementations, the functions noted in the blocks may occur out of the order noted or in different configurations of hardware and software. For example, two blocks shown in succession may, in fact, be executed substantially concurrently, or the blocks may sometimes be executed in the reverse order, depending on the functionality involved.

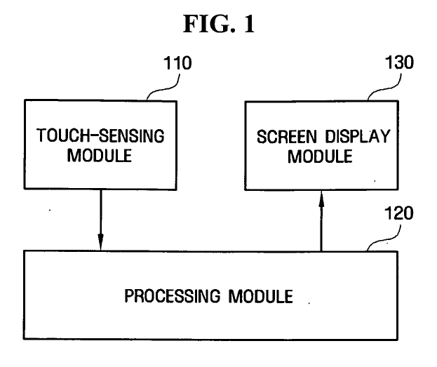

FIG. 1 is a block diagram of an electronic device according to an exemplary embodiment of the present invention.

A touch-sensing module 110 senses a touch on a touch screen or a touch pad. The touch-sensing module 110 senses the touch of a user's finger, a stylus pen, or a touch pen and transmits the location of the touch and a change in the touch to a processing module 120. The touch-sensing module 110 may be based on a variety of sensing technologies including, but not limited to, resistive, surface acoustic wave, capacitive, infrared and/or the like. The touch-sensing module 110 may be incorporated into the touch screen together with a screen display module 130, or may be implemented by a standalone hardware circuit such as a touch pad.

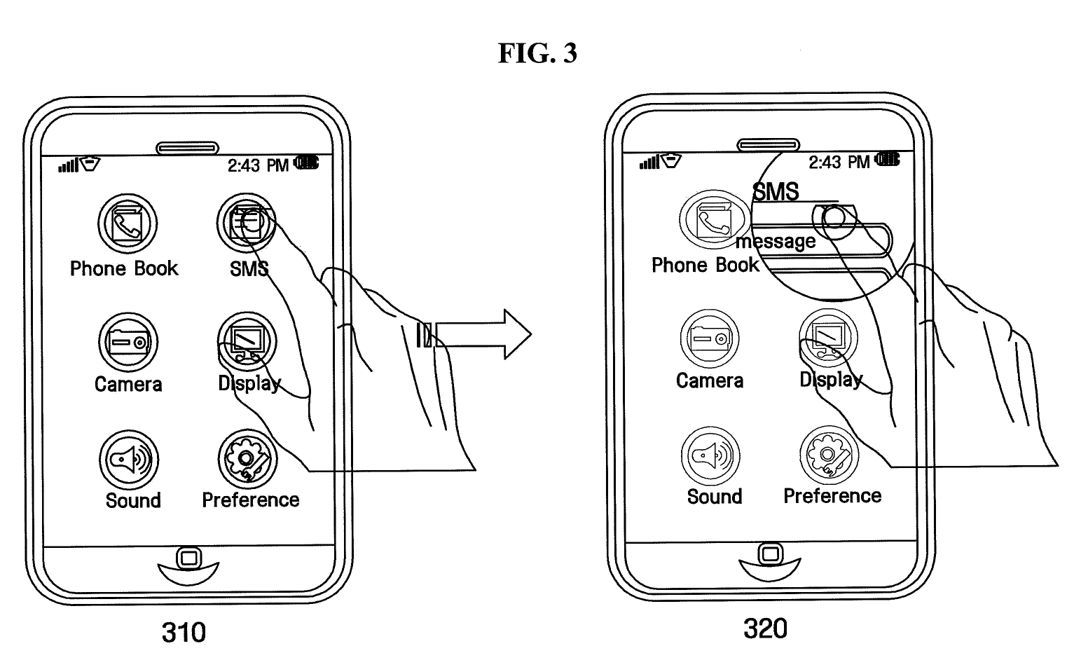

The processing module 120, which is connected to the touch-sensing module 110, processes the location of the touch and the change in the touch, which are received from touch-sensing module 110. The processing operations for the location of the touch and the change in the touch will be described below with reference to FIGS. 3 through 8. The processing module 120 preferably includes a processor such as a single-chip, a multi-chip, or ASIC, an operation system such as Windows OS, Mac OS, OS/2, DOS, Unix, Linux, or Palm OS, a computer program designed as C/C++, JAVA, BASIC, or the like, or a storage device storing a computer program, such as ROM, RAM, HDD, or a CD-ROM.

The screen display module 130, which is connected to the processing module 120, displays a processing result output from the processing module 120 on a screen. The screen display module 130 may be incorporated into the touch screen together with the touch-sensing module 110, or may be implemented by a standalone display. The screen display module 130 preferably includes a screen display device such as LCD, CRT, or OLED, and a graphics processing unit (GPU). The screen display module 130 displays GUI objects generated by the processing module 120 on the display screen.

Meanwhile, the term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

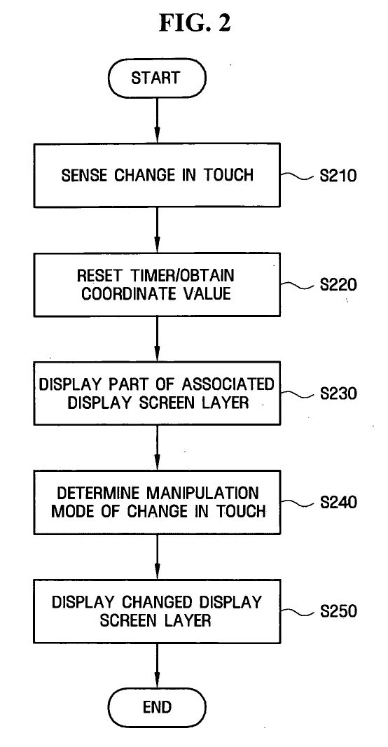

FIG. 2 is a flowchart illustrating a method of operating an electronic device according to an exemplary embodiment of the present invention.

If a user touches a touch screen or a touch pad using a finger or a stylus pen, the touch-sensing module 110 senses a touch in S210. If the touch is sensed, the touch-sensing module 110 transmits the sensed touch to the processing module 120.

The processing module 120 receives information about the touch from the touch-sensing module 110, resets a timer and obtains a coordinate value corresponding to a location of the touch in S220. The processing module 120 determines the location of the touch among the GUI objects displayed on the display screen to determine a display screen layer associated with the location of the touch. The processing module 120 causes the display screen layer to be displayed through the screen display module 130.

The screen display module 130 displays a part of the display screen layer determined by the processing module 120 on the display screen in S230. Preferably, the screen display module 130 displays the part of the display screen layer such that the part of the display screen layer is seamlessly displayed from the location of the touch, or the part of the display screen layer looks depressed by making its boundary with the original display screen layer blurred. The displaying method will be described below with reference to FIGS. 3 through 5 in greater detail.

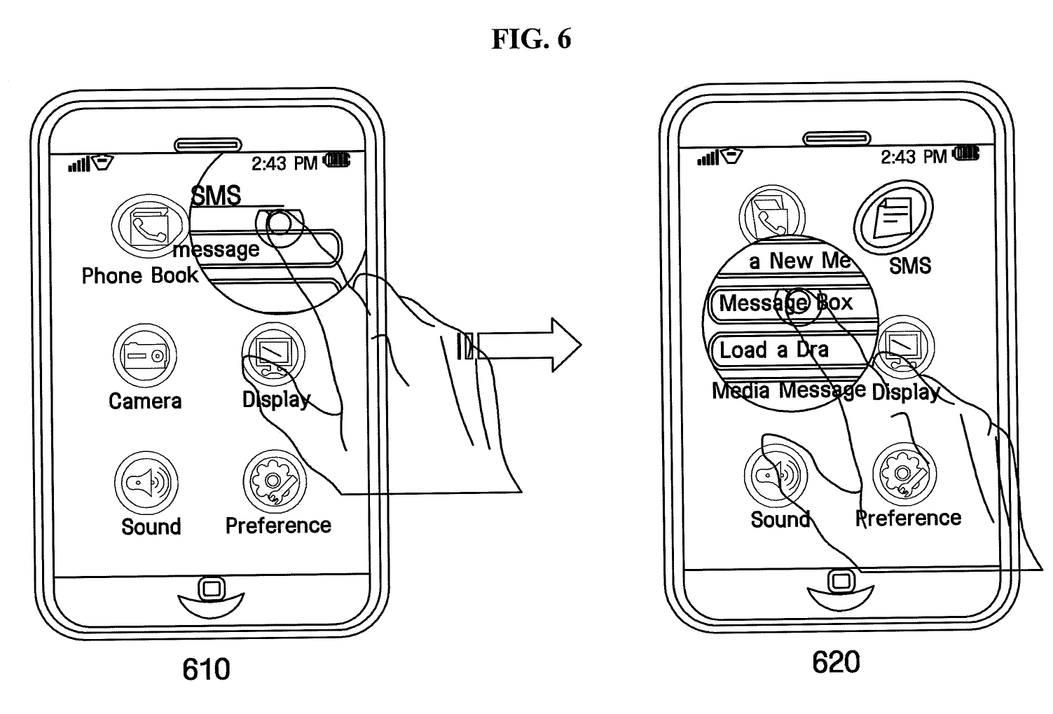

If the touch-sensing module 110 senses a change in the touch, the touch-sensing module 110 notifies the processing module 120 of the change in the touch and the processing module 120 determines a manipulation mode of the change in the touch in S240. In detail, the processing module 120 determines whether the change in the touch is based on a drag operation in which the location of the touch is changed, a holding operation in which the touch is maintained for a predetermined period of time or pressure exerted to a location of the touch is increased, a flicking operation in which the location of the touch is changed within a predetermined period of time to then release the touch, or a release operation in which the touch is released. The processing results will be described below with reference to FIGS. 6 through 8 in greater detail.

The screen display module 130 displays a display screen layer changed based on a processing result output from the processing module 120 in S250. The screen display module 130 displays the processing result on the display screen with respect to the change in the touch as determined by the processing module 120. The displaying method will be described below with reference to FIGS. 6 through 8 in greater detail.

FIGS. 3 through 5 are views illustrating exemplary display screens displayed by touching the display screens in a method of operating an electronic device according to an exemplary embodiment of the present invention.

If a user selects and touches an object, such as a GUI icon or menu, displayed on a touch screen, a part of a sub-menu display screen layer corresponding to the object is displayed at the location of the touch.

Referring to FIG. 3, if the user touches a display screen of the touch screen by selecting an SMS icon, as shown by reference number 310, a sub-menu display screen layer is seamlessly displayed around the location of the touch while the display screen layer looks depressed relative to an original display screen layer by making its boundary with the original display screen layer blurred, as shown by reference number 320. The sub-menu display screen layer corresponding to the selected SMS icon is a menu display screen layer displayed by clicking or tapping the SMS icon.

If the touch-sensing module 110 senses a touch, the touch-sensing module 110 notifies the processing module 120 of the location of the touch. Based on the notified location of the touch, the processing module 120 determines which icon the user has selected. If the processing module 120 identifies the location of the touch through the SMS icon selected by the user, a sub-menu display screen layer associated with the SMS icon is selected and a part of the sub-menu layer is displayed by means of the screen display module 130.

If the user releases the touch, the sub-menu layer disappears slowly from its edges, as shown by reference number 310. When the touch-sensing module 110 senses the released touch, the processing module 120 determines whether the screen display module 130 has released the touch without movement, and causes an original display screen to be restored.

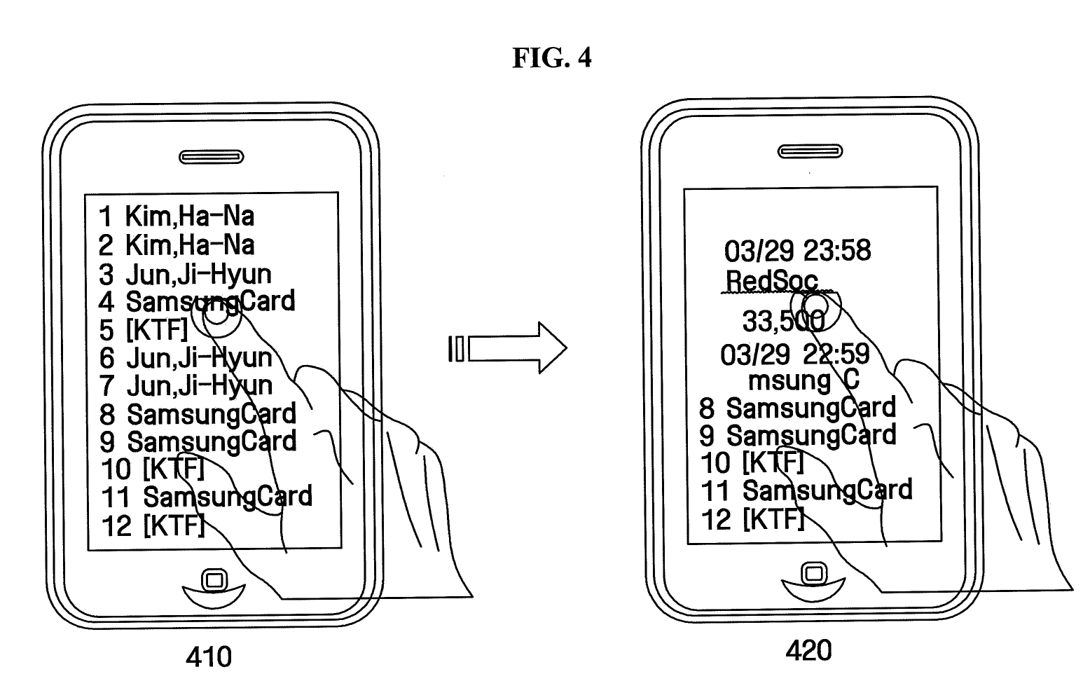

Referring to FIG. 4, when the user touches the touch screen by selecting one of SMS items, as shown by reference number 410, a part of the sub-menu layer is displayed around the location of the touch, as shown by reference number 420.

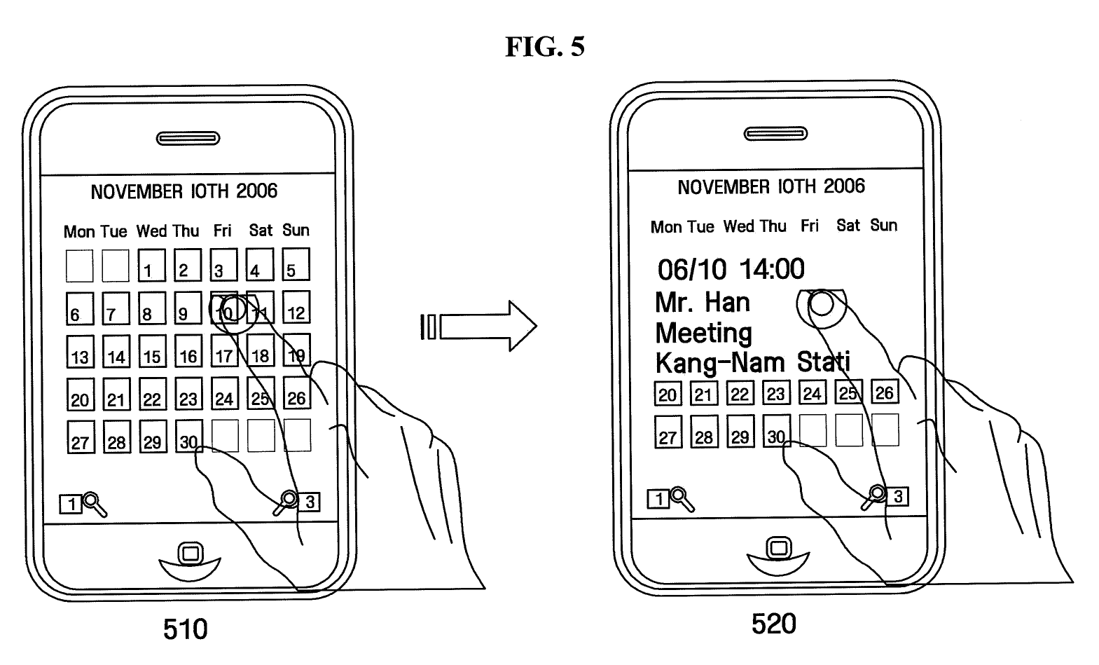

Referring to FIG. 5, if the user touches a touch screen of a personal information management system (PIMS) by selecting a date from the PIMS, as shown by reference number 510, a part of a display screen containing appointments, to-do lists, etc. for the selected date is displayed, as shown by reference number 520.

FIG. 6 is a view illustrating an exemplary display screen displayed when a location of a touch is moved in a method of operating an electronic device according to an exemplary embodiment of the present invention.

If the user moves the location of the touch, as shown by reference number 610, other parts of a sub-menu layer display screen layer are shown according to the location of the touch, as shown by reference number 620. Therefore, the user is able to view all the content of the sub-menu display screen layer.

If the touch-sensing module 110 senses a change in the location of the touch, the processing module 120 is notified of the changed location of the touch and the released touch. The processing module 120 processes the screen display module 130 to continuously display the part of the sub-menu layer display screen layer around the location of the touch.

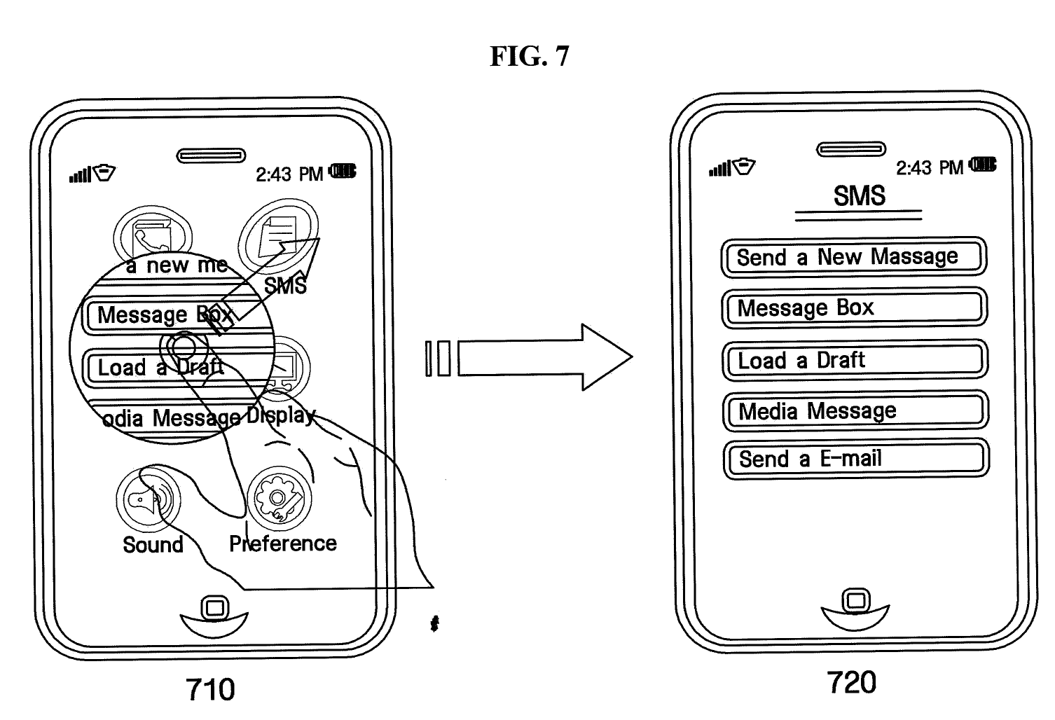

FIG. 7 is a view illustrating an exemplary display screen displayed when a location of a touch is moved and the touch is then released in a method of operating an electronic device according to an exemplary embodiment of the present invention.

If a user moves the location of the touch quickly, that is, within a short period of time, as shown by reference number 710, and then releases the touch, the whole sub-menu display screen layer is seamlessly displayed, as shown by reference number 720. That is, when the user manipulates the touch screen as if the original layer was quickly pushed and cast 710, the whole sub-menu layer is seamlessly displayed 720.

If the touch is flicked, that is, if the location of the touch is changed and the touch is then released, the touch-sensing module 110 notifies the processing module 120 of a flicking operation. If the processing module 120 determines that the flicking operation is to be performed, the processing module 120 processes the screen display module 130 to display the whole sub-menu display screen layer.

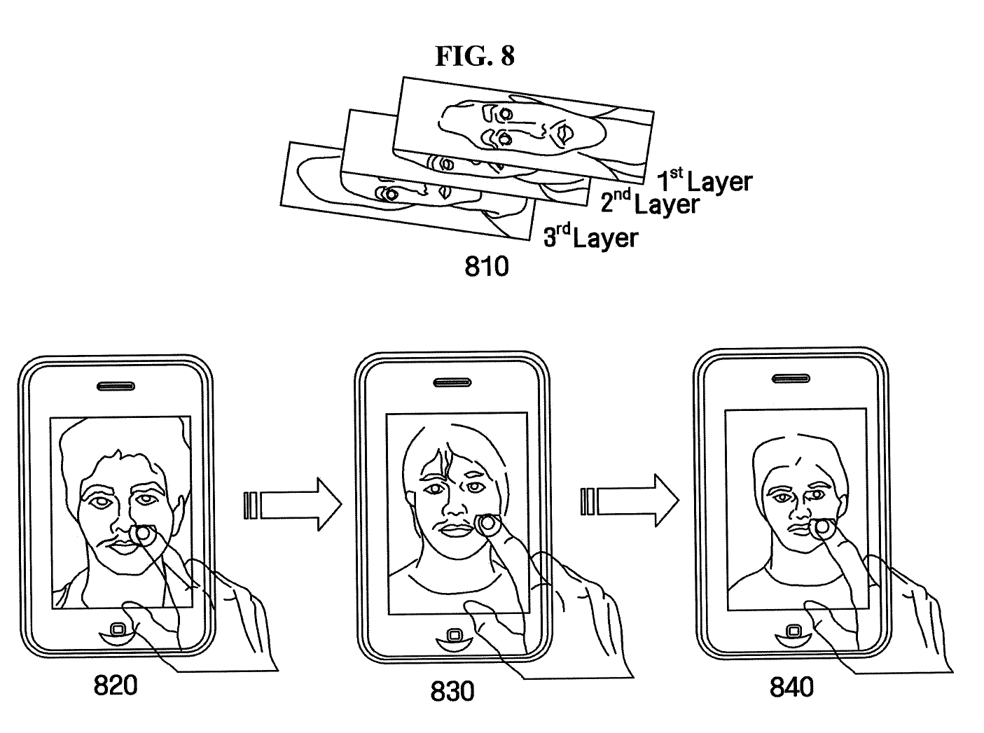

FIG. 8 is a view illustrating an exemplary display screen displayed when touch is maintained for a predetermined time in a method of operating an electronic device according to an exemplary embodiment of the present invention.

An assumption is made that three layers of three photo images, as shown by reference number 810, are stored in an electronic device. If a user touches a first layer of a fist photo image for more than a predetermined period of time, as shown by reference number 820, a second layer of a second photo image is displayed, as shown by reference number 830. If the user continuously touches the second layer 830, a third layer of a third photo image is displayed, as shown by reference number 840.

In an alternative exemplary embodiment of the present invention, a display screen may be displayed in a variable manner according to the pressure of the touch. Specifically, if the user presses down the first layer with increased pressure 820, the second layer is displayed on the display screen 830. If the user presses down the second layer 830 with further increased pressure, the third layer is displayed on the display screen 840.

That is, the touch-sensing module 110 measures the intensity of touch pressure and transmits the measured intensity to the processing module 120. The processing module 120 determines whether the touch pressure is increased. If the touch pressure is increased, the processing module 120 processes the screen display module 130 to display a sub-menu display screen layer.

The electronic device and the method of operating the same according to the present invention produce one or more of the following effects.

First, associated content and menu items can be previewed or selected by a one-time manipulation.

Second, realistic visual effects and enhanced image vividness are provided, thereby offering an intuitive GUI to users.

The effects of the present invention should not be limited to the foregoing description, and additional effects and advantages of the invention will be made more apparent to those skilled in the art from the spirit and scope of the invention as defined by the appended claims.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present exemplary embodiments be considered in all respects as illustrative and not restrictive, reference being made to the appended claims rather than the foregoing description to indicate the scope of the invention.

What is claimed is:

1. An electronic device comprising:
a touch-sensing module which senses a touch;
a processing module which determines a display screen layer associated with a location of the touch; and
a screen display module which displays a part of the display screen layer.

2. The electronic device of claim 1, wherein the screen display module blurs a portion of the part of the display screen layer at a boundary between the part of the display screen layer and an original display screen layer.

3. The electronic device of claim 1, wherein the screen display module displays the part of the display screen layer such that the part of the display screen layer appears depressed by blurring a boundary between the part of the display screen layer and an original display screen layer.

4. The electronic device of claim 1, wherein the screen display module displays the part of the display screen layer while the part of the display screen layer is displayed in proximity to the location of the touch.

5. The electronic device of claim 1, wherein if the processing module determines a change in the location of the touch, then the screen display module displays another part of the display screen layer based on the changed location of the touch.

6. The electronic device of claim 1, wherein if the processing module determines that the touch is maintained for a period of time, then the screen display module displays a whole of the display screen layer associated with the location of the touch.

7. The electronic device of claim 6, wherein if the processing module determines that the touch is continuously maintained for a period of time after the whole of the display screen layer associated with the location of the touch is displayed, then the screen display module displays a next display screen layer associated with the location of the touch.

8. The electronic device of claim 1, wherein if the processing module determines that pressure exerted to the location of the touch is increased, then the screen display module displays a whole of the display screen layer associated with the location of the touch.

9. The electronic device of claim 8, wherein if the processing module determines that the pressure exerted to the location of the touch is continuously increased after the whole of the display screen layer associated with the location of the touch is displayed, then the screen display module displays a next display screen layer associated with the location of the touch.

10. The electronic device of claim 1, wherein if the processing module determines that the location of the touch is changed within a period of time and the touch is then released, then the screen display module displays a whole of the display screen layer associated with the location of the touch.

11. The electronic device of claim 1, wherein if the processing module determines that the touch is released, then the screen display module displays the display screen layer such that the display screen layer disappears and the original display screen layer is displayed.

12. The electronic device of claim 11, wherein the screen display module displays the display screen layer such that the display screen layer disappears slowly from its edges.

13. A method of operating an electronic device comprising:
sensing a change in a touch;
displaying a part of a display screen layer associated with a location of the touch;
determining a manipulation mode of the change in the touch; and
displaying a changed display screen layer according to the change in the touch.

14. The method of claim 13, wherein a portion of the part of the display screen layer is blurred at a boundary between the part of the display screen layer and an original display screen layer.

15. The method of claim 13, wherein the part of the display screen layer is displayed such that it looks depressed relative to an original display screen layer.

16. The method of claim 13, wherein the displaying of the part of the display screen layer comprises displaying the part of the display screen layer while the part of the display screen layer is displayed in proximity to the location of the touch.

17. The method of claim 13, wherein the determining comprises determining whether the location of the touch has changed, and the displaying of the changed display screen layer comprises displaying another part of the changed display screen layer based on the changed location of the touch.

18. The method of claim 13, wherein the determining comprises determining whether the touch is maintained for a period of time, and the displaying of the changed display screen layer comprises displaying a whole of the display screen layer associated with the location of the touch.

19. The method of claim 18, further comprising:
determining whether the touch is continuously maintained for a period of time after the whole of the display screen layer associated with the location of the touch is displayed; and
displaying a next display screen layer associated with the location of the touch.

20. The method of claim 13, wherein the determining comprises determining whether a pressure of the touch is increased, and the displaying of the changed display screen layer comprises displaying a whole of the display screen layer associated with the touch location.

21. The method of claim 20, further comprising:
determining whether the touch pressure is continuously increased after the whole of the display screen layer associated with the location of the touch is displayed; and
displaying a next display screen layer associated with the location of the touch.

22. The method of claim 13, wherein the determining comprises determining whether the location of the touch is changed within a period of time, and the displaying of the changed display screen layer comprises displaying a whole of the display screen layer associated with the location of the touch.

23. The method of claim 13, wherein the determining comprises determining whether the touch is released, and the displaying of the changed layer comprises displaying the display screen such that the display screen layer disappears and an original display screen layer is displayed.

24. The method of claim 13, wherein the displayed display screen layer disappears slowly from its edges.
